(19) United States
(12) Patent Application Publication
(10) Pub. No.: US 2025/0194846 A1
(43) Pub. Date: Jun. 19, 2025

(54) HEAT-INSULATED FILTER HOLDER FOR AN ESPRESSO COFFEE MACHINE

(71) Applicant: LA MARZOCCO S.R.L., Scarperia E San Piero (IT)

(72) Inventors: Simone GUCCI, Scarperia E San Piero (IT); Stefano DELLA PIETRA, Scarperia E San Piero (IT); Riccardo MARCHI, Scarperia E San Piero (IT); Riccardo GATTI, Scarperia E San Piero (IT)

(21) Appl. No.: 18/716,443

(22) PCT Filed: Dec. 8, 2022
(86) PCT No.: PCT/IB2022/061923

§ 371 Date: Jul. 3, 2024

(30) Foreign Application Priority Data
Dec. 9, 2021 (IT) 102021000030974

(51) Int. Cl. A47J 31/06

(52) U.S. Cl. CPC A47J 31/0663

(57) ABSTRACT

A filter holder for a machine for preparing and dispensing espresso coffee is described, said filter holder comprising a handle, a body connected to the handle and configured to house a filter for ground coffee, and a base cup, wherein the base cup is substantially made of any material from among polysulfides, polyethers, polyaryletherketones, polyphenylsulfones and polysulfones, or the base cup is made of glass, or ceramic, or porcelain, or a combination thereof.

### BACKGROUND

The present invention relates in general to the sector of espresso coffee machines. More particularly, it relates to a filter holder with a part thereof which is heat-insulated.

### PRIOR ART

Many machines for preparing beverages are known. In particular, many machines for the preparation of espresso coffee from coffee powder, pods, capsules or the like are known.

Typically, in a machine for the preparation of espresso coffee, a puck of ground coffee is crossed by a water flow under high pressure and at a high temperature. In some of the known machines it is possible to adjust precisely the pressure and/or the temperature of the water which crosses the puck of coffee. In some known machines, it is possible to modify the pressure and/or the temperature of the water during dispensing.

Typically, an espresso coffee machine comprises at least one dispensing unit on which a filter holder arm—also referred to simply as “filter holder”—is mounted.

The filter holder generally comprises a body and a handle. The body has a substantially cylindrical cross-section and is open at the top. A filter, which is a cup-shaped receptacle with a bottom having a plurality of small holes, is housed inside the filter holder body. A certain amount of ground coffee is filled inside the filter and is generally compressed by the barista manually or using special devices.

Typically, the body of the filter holder has a bottom configured so as to direct the coffee produced towards an outlet spout which creates a flow of espresso coffee and guides it towards a coffee cup. The output spout may be single or double.

EP 2,087,818 A1 describes a filter holder for a coffee machine.

### SUMMARY OF THE INVENTION

As is known, the dispensing of espresso coffee is performed at a high temperature and under high pressure.

Many manufacturers have studied and implemented measures for reducing the heat dispersion during the preparation of an espresso coffee, so that the coffee is dispensed at the desired temperature.

In professional espresso coffee machines a relatively long period of time is required in order to heat the machine. Some baristas, in order to eliminate this waiting time, have the habit of switching on the machine also during the night-time hours or in any case during periods of inactivity. In any case, during the daytime, usually the machine remains heated since it continues to dispense coffee, especially during certain times of the day.

In espresso coffee machines for domestic use (or for limited professional use, for example those installed in small restaurants), the waiting time needed to allow the machine to heat up is problematic. In fact, the waiting time of a few minutes is a nuisance for a user who wants to prepare a coffee just for him/herself or a guest. Some espresso coffee machines for domestic use have a waiting time of between 5 and 10 minutes.

The Applicant has defined the aim of reducing the waiting time of an espresso coffee machine.

The Applicant has examined the final part of the path for preparation of an espresso coffee, in particular downstream of the filter.

According to the Applicant, a not insignificant part of the heat of an espresso coffee is lost at the bottom of the filter holder body and the spout. In fact, the filter holder body made of metallic material remains cold, i.e. at room temperature. When the coffee emerges from the holes in the filter and comes into contact with the bottom of the filter holder it cools down significantly. This negatively affects the taste, in particular of the amount of coffee which flows out first and fills the bottom of the coffee cup.

According to the Applicant, the problem may be solved by providing a filter holder with a metallic body having an open bottom and by providing a base cup made of a material having a thermal conductivity less than that of the metal body.

According to one aspect of the invention, a filter holder for a machine for preparing and dispensing espresso coffee is described, said filter holder comprising a handle, a body connected to the handle and configured to house a filter for ground coffee, and a base cup, wherein the base cup is substantially made of any material from among polysulfides, polyethers, polyaryletherketones, polyphenylsulfones, polysulfones or the like, or the base cup is made of glass. or ceramic, or porcelain, or a combination thereof.

According to embodiments, the base cup is substantially made of polyphenylene sulfide (PPS). For example, a material tested and considered to be suitable is Ryton R-4-244 NA (or other material in the same series), produced by Solvay, which is a high-modulus polyphenylene sulfide (PPS).

According to embodiments, the base cup is substantially made of polyether ether ketone (PEEK).

According to embodiments, the base cup is substantially made of polyphenylsulfone (PPSU). For example, a material tested and considered to be suitable is Radel 5100 (or other material in the same series), produced by Solvay, a material with optimum mechanical and thermal characteristics, as well as being food-grade certified.

According to embodiments, the base cup is a component which is separate and/or separable from the body and wherein the filter holder is substantially made of a metallic material having a thermal conductivity less than 150 W·m⁻¹·K⁻¹.

For example, the metallic material is steel, preferably chrome-plated steel, or brass, preferably chrome-plated brass.

The body of the filter holder according to the invention is not made of aluminum or alloys thereof. In fact, aluminum has a thermal conductivity which is too high (greater than 200 W·m⁻¹·K⁻¹) and thus transmits a high thermal energy to the base cup during use when preparing an espresso coffee.

For the purposes of the present description and the following claims, the expression “substantially made of . . . [material]” relating to a component such as the body or the base cup, indicates that said component is mainly made of a certain specific material. Therefore, for example if the filter holder body is made of steel, which is chrome-plated on the surface, it falls within the definition of a “filter holder body substantially made of steel”. Therefore, the application of a surface layer does not influence the general composition of a component.

According to embodiments, the material of the base cup is a material which satisfies the food safety requirements (for example the NSF food contact certification). Preferably, the material has a good thermal stability and good mechanical impact resistance.

According to embodiments the base cup is at least partially transparent.

According to embodiments, the base cup comprises a substantially smooth internal surface.

According to embodiments, the base cup comprises an internal surface with scorings and/or reliefs.

According to embodiments, the body comprises a flat support member for supporting the filter holder to facilitate the pressing of the ground coffee inside the filter.

According to embodiments, the support member comprises a tooth protruding radially towards the outside of the body, preferably in a direction substantially opposite to the handle, and formed as one piece with the body.

According to embodiments, the body comprises a first front flange with a first internal groove, a second rear flange with a second internal groove, and two opposite open recesses between the first flange and the second flange.

According to embodiment, the first internal groove and the second internal groove open out into the open recesses, wherein the base cup comprises a first front tooth configured to engage the first internal groove and a second rear tooth configured to engage the second internal groove for coupling the base cup to the body.

According to embodiments, the filter holder further comprises a retaining member, preferably a ball presser, for providing a further retaining action between the base cup and the body.

According to embodiments, the filter holder further comprises a protruding lug configured to engage the free edge of the second rear flange.

According to embodiments, the filter holder further comprises oppositely arranged whiskers configured to determine the correct angular abutting position of the base cup on the body of the filter holder. According to embodiments, the material of the base cup is a material resistant to contact with a liquid substance having a temperature of at least 100° C.

### BRIEF DESCRIPTION OF THE FIGURES

A detailed description of the present invention now follows, being provided purely by way of a non-limiting example, to be read with reference to attached figures in which:

FIG. 1 is an axonometric view of an example of an espresso coffee machine in which the filter holder according to the present invention may be used;

FIGS. 2, 2A and 3 show a bottomless filter holder according to an embodiment of the invention.

FIGS. 4, 5 and 6 show the base cup of the filter holder according to an embodiment of the present invention;

FIGS. 7, 7A and 8 show the filter holder with heat-insulated base cup according to an embodiment of the present invention;

FIGS. 9A, 9B and 9C are various axonometric views of a filter holder body according to a second embodiment of the invention;

FIGS. 10A and 10B are two axonometric views of the base cup configured to be coupled together with the filter holder body of FIG. 9;

FIG. 11 is a view of the body and the base cup according to FIGS. 9 and 10 in the separated condition, namely before engagement together;

FIG. 12 is a view of the body and the base cup during a first phase for coupling them together; and

FIGS. 13 and 14 are two axonometric views, from two different angles, of the filter holder body and the base cup coupled together in the final position.

### DETAILED DESCRIPTION

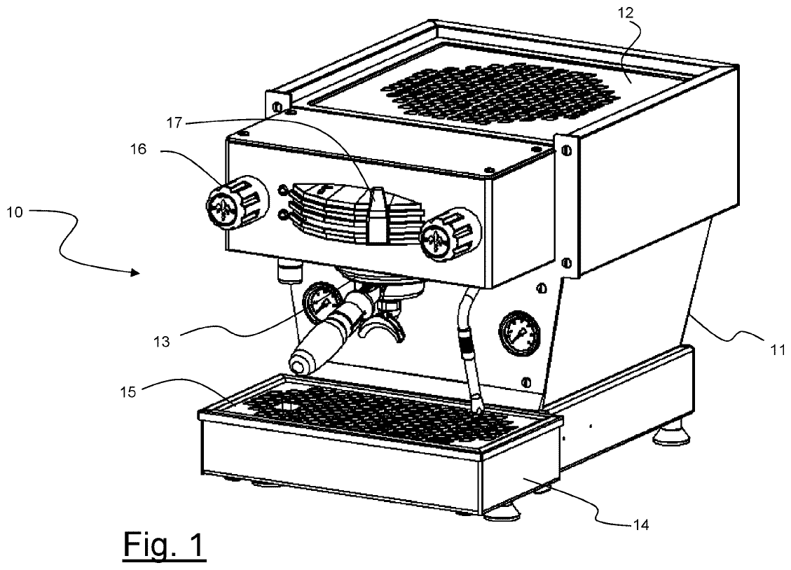

FIG. 1 shows, purely by way of example, an espresso coffee machine, denoted overall by the reference number 10. The machine 10 comprises a substantially closed machine body 11 inside which the main machine components-some of which will be described below—are housed. At the top, preferably, the machine 10 comprises a surface 12 for resting the coffee cups. An electric resistance (not shown) or other heating system for heating the cups on the surface 12 may also be provided.

The machine 10 comprises a dispensing unit 13 for dispensing espresso coffee. Underneath the dispensing unit 13 there is preferably arranged a drip tray 14, which is preferably partially closed at the top by a grille 15. Typically, the coffee cups are placed on the grille 15 during dispensing of the espresso coffee.

A filter holder, which in turn houses and supports a filter for a puck of coffee powder, can be removably engaged together with the dispensing unit 13.

The machine 10 may comprise one or more displays and/or pushbuttons and/or knobs 16, for example for switching on/off the machine and/or for starting/stopping the dispensing operation.

The machine 10 shown in FIG. 1 also comprises a lever 17 for starting/stopping the dispensing of the espresso coffee and/or for modifying the dispensing pressure during dispensing of the espresso coffee.

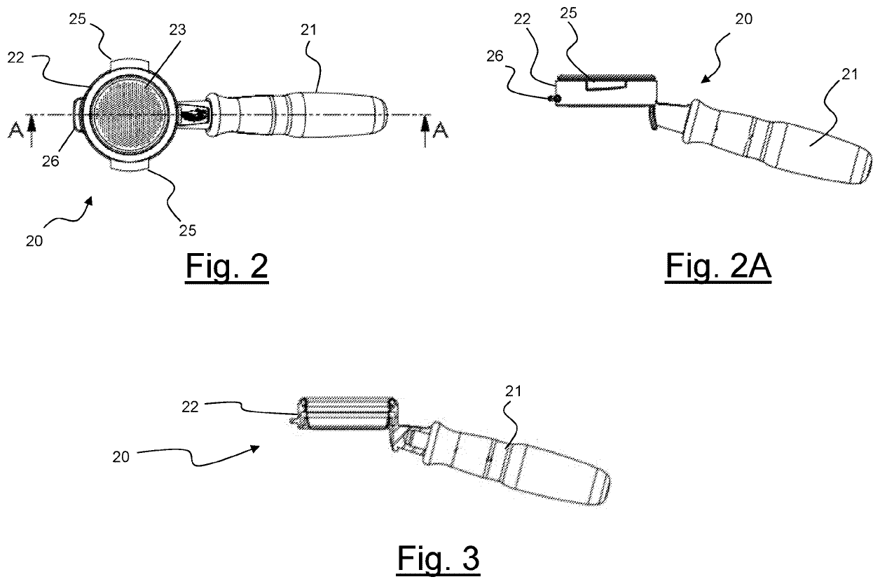

FIG. 2 shows a bottomless filter holder 20 onto which a heat-insulated base cup 30 according to the present invention may be mounted.

Preferably, the filter holder 20 comprises a handle 21 and a substantially cylindrical body 22 which is configured to retain a filter 23 which is filled with coffee powder.

Preferably, the filter 23 is cup-shaped, open at the top and has a bottom which is closed, but has a plurality of micro-holes on the bottom. Preferably, a filter retaining clip is provided for keeping the filter 23 in position. The filter retaining clip may be housed inside a groove in an inner wall of the body 22 of the filter holder 20.

Preferably, the outer surface of the body 22 has, projecting therefrom, two diametrically opposite fins 25, configured to engage the filter holder 20 with the dispensing unit 13. The engagement between the filter holder and the dispensing unit may also be performed by means of a rotational movement, translational movement or combined rotational and translational movement.

According to embodiments of the present invention, a support member 26 is provided for facilitating supporting of the filter holder 20 when the user must press the ground coffee inside the filter 23. As is known, in fact, the ground coffee typically is filled inside the filter and then pressed manually, for example by means of a tamper.

As shown in FIGS. 2, 2A and 3, the support member 26 may be in the form of a tooth 26 protruding radially from the filter holder body. The support tooth 26 may project radially towards the outside from a point substantially opposite to the handle 21 of the filter holder 20. By means of the support tooth, the person who must perform pressing rests the filter holder 20 on the edge of a counter or worktop, using one hand to support the filter holder and the other hand to press the ground coffee inside the filter.

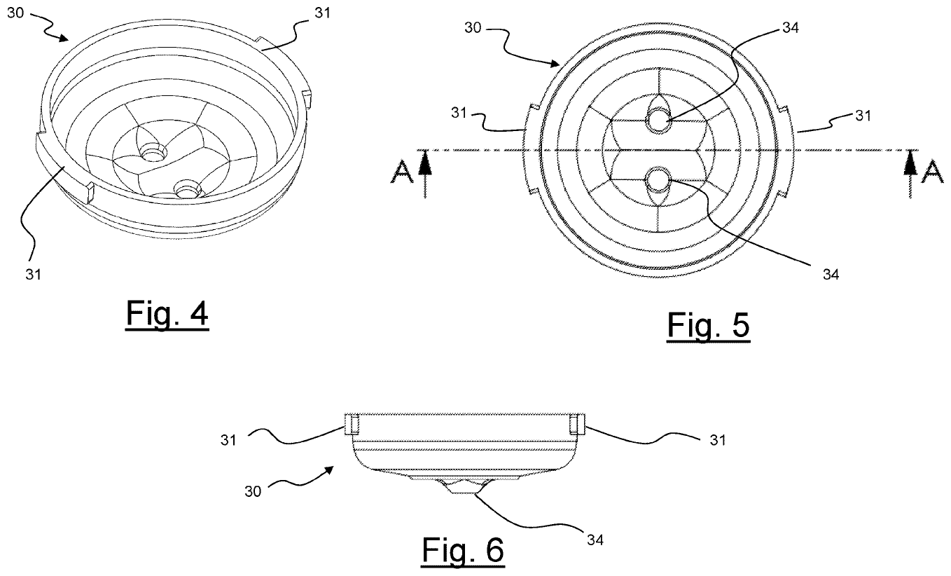

FIGS. 4, 5 and 6 show the base cup 30 of the filter holder according to the present invention. The base cup 30 is a member which is separate from the filter holder body and may be mounted and removed simply and quickly. One of the advantages consists in the fact that the base cup 30 is separate from the filter holder body 22 and that the base cup 30 may be washed more thoroughly, manually or mechanically (for example in a dishwasher).

Typically the base cup 30 of the filter holder may have a circular form when viewed in a top plan view. Preferably, the base cup 30 of the filter holder has an upper lip 31 protruding externally to form a support surface.

Preferably, the base cup 30 of the filter holder has a substantially frustoconical shape so as to direct the coffee towards a single outlet opening or towards a double outlet opening as shown in FIGS. 4, 5 and 6. The double outlet opening is typically designed to dispense the coffee into two different coffee cups.

The Applicant has considered that a thermoplastic material such as PBT is a material which is too sensitive to hydrolysis, namely contact with water at high temperatures. In particular, it is sensitive to contact with water at a temperature higher than 60° C. Therefore, PBT is unsuitable for contact with espresso coffee which is dispensed at a temperature of 80° C. or higher. Typically an espresso coffee reaches even a temperature of 90° C. or higher.

The Applicant has investigated the use of different materials for manufacture of the base cup. In particular, the Applicant has tested some materials chosen from polysulfides, polyethers, polyaryletherketones, polyphenylsulfones, polysulfones or the like, or glass, or ceramic, or porcelain, or a combination thereof.

According to embodiments, the base cup is substantially made of polyphenylene sulfide (PPS). For example, a material tested and considered to be suitable is Ryton R-4-244 NA, produced by Solvay, which is a high-modulus polyphenylene sulfide (PPS).

According to embodiments, the base cup is substantially made of polyether ether ketone (PEEK).

According to embodiments, the base cup is substantially made of polyphenylsulfone (PPSU). For example, a material tested and considered to be suitable is Radel 5100, produced by Solvay, a material with optimum mechanical and thermal characteristics, as well as being food-grade certified.

This material is a polyphenylsulfone (PPSF or PPSU), a polymer made of aromatic rings linked by sulfonyl groups (SO₂).

On the other hand, PBT is a polyester, namely comprising ester repeating units (—COOR).

PPSU is amorphous, while PBT is semi-crystalline.

The base cup 30 of the filter holder is in any case made of a material with a thermal conductivity less than the thermal conductivity of the filter holder body (which is typically made of metal, such as steel or brass). Advantageously, the base cup of the filter holder may be made by means of die-pressing. Alternatively, it may be made of ceramic, or porcelain, or glass, or a combination thereof.

In the present description and in the claims, the thermal conductivity is expressed in units of the International System. In particular, the thermal conductivity is measured in W·m⁻¹·K⁻¹ (watt per meter-kelvin), the watt being the unit of measurement for power, the meter the unit of measurement for length, and kelvin the unit of measurement for temperature.

According to embodiments, the material of the base cup has a thermal conductivity of between 0.1 and 0.5. According to embodiments, said material has a thermal conductivity of less than 0.4. However, in the case where the base cup is made of ceramic, or porcelain, or glass (or also a combination thereof), the thermal conductivity would be greater than the aforementioned value, for example between 1 and 1.70, in any case less than 5 and preferably less than 2.

Preferably, the thickness of the base cup may be between 0.5 mm and 3 mm, for example 1 mm or 2 mm.

According to embodiments, the base cup 30 is made of a material which is at least partially transparent so as to allow the user to see the coffee which flows out through the micro-holes in the filter. As is known, preferably the coffee flows out in a uniform manner from the filter, without following preferential paths. If the material of the filter holder bottom is at least partially transparent, the user may check the uniformity with which the coffee flows out from the filter. In the event of a non-uniform flow, the user may take remedial action, carefully cleaning the micro-holes of the filter or replacing the filter. If necessary, technical assistance may be requested, with pictures or videos being attached to the request.

The inner surface of the base cup may be substantially smooth so that the espresso coffee flows freely towards the single opening or double opening. Alternatively, the inner surface of the base cup may comprise superficial reliefs so as to create paths, for example channels. According to embodiments, the superficial reliefs are configured so as to create vortices and/or winding paths. Said vortices or winding paths have the effect of mixing or dividing the flow in a uniform manner should two outlets be present.

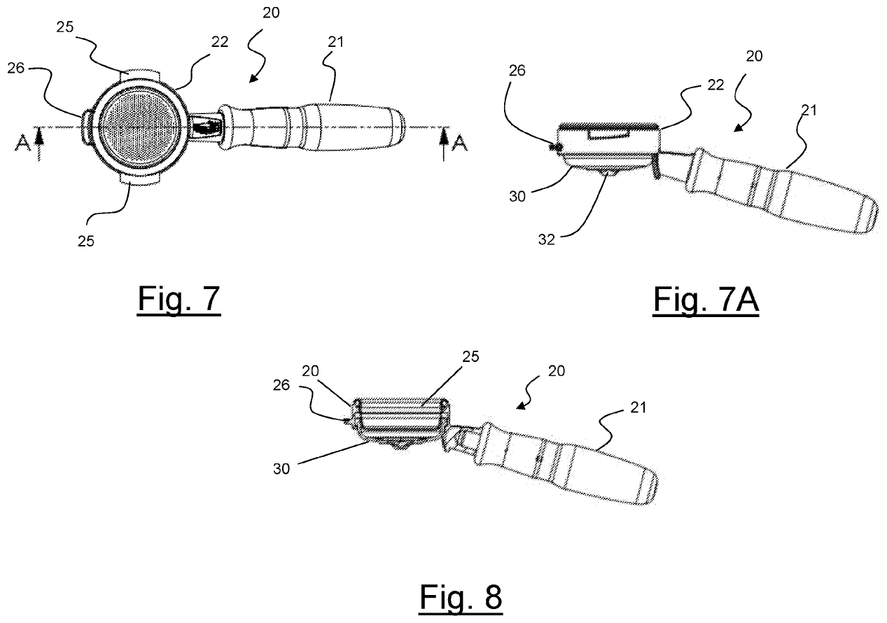

FIGS. 7, 7A and 8 are similar to FIGS. 2, 2A and 3 and show the heat-insulated base cup 30 mounted on the body 22 of the filter holder 20.

At this point the advantages of the present invention will be clear. Firstly, the present invention allows the time needed for the heating phase to be reduced significantly.

The filter holder with heat-insulated base cup reduces by two thirds the amount of metal present in the filter holder, while keeping metallic the part making contact between the dispensing unit and filter, exploiting the high thermal conductivity thereof and allowing rapid heating-up of the filter.

The base cup 30 replaces part of the standard filter holder and spouts conventionally made of metal. Since the base cup is made of material with a low thermal conductivity, it will not remove heat from the dispensing water and it will therefore not be necessary to wait for heating-up of the entire filter holder as in a known filter holder.

The system heating-up time will correspond therefore to heating of the filter alone which, from laboratory tests, takes about 2 minutes.

Secondly, the present invention allows the temperature to be maintained during dispensing of an espresso coffee.

In fact, since the heat-insulated base cup tends to draw off a smaller amount of heat than a known filter holder, the entire system will not influence the beverage dispensing temperature set by the user for a particular formulation. This will allow better repeatability of the organoleptic characteristics of the beverage.

Thirdly, the present invention allows the possibility of better cleaning of the filter holder and in particular the bottom thereof. In fact, the heat-insulated base cup is removable without the use of tools. It is also possible to insert the removable base cup in dishwashers for thorough cleaning thereof.

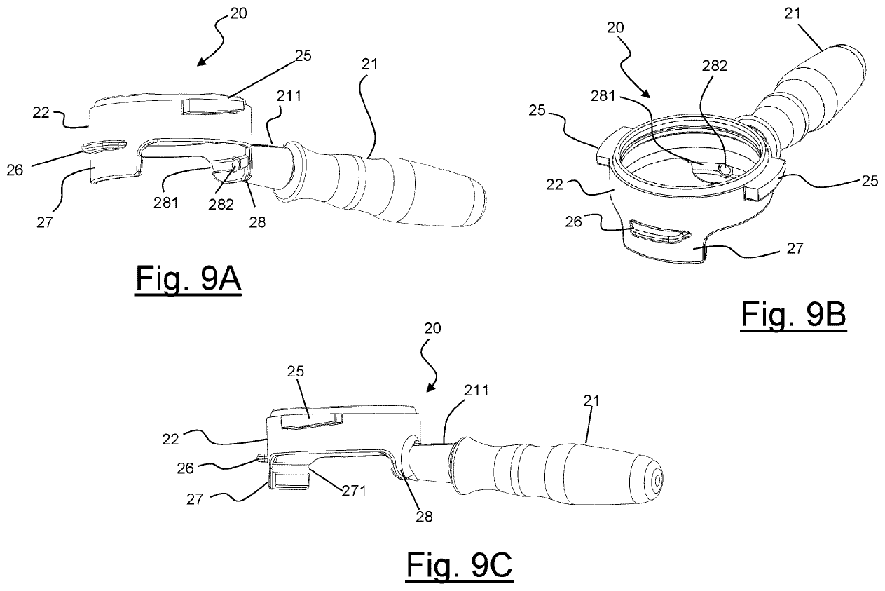

Fourthly, when the base cup 30 of the filter holder is made of an at least partially transparent material, it is possible to monitor the outflow of the coffee from the filter so as to identify any dispensing problems or also simply enjoy watching the coffee flow out from the filter. FIGS. 9-14 show an embodiment of the filter holder according to the invention in which the engagement between the filter holder body and the base cup is particularly easy, efficient and resistant. In fact the Applicant has realized that the removal and reassembly operations depend on the need for frequent cleaning. Furthermore, since there is the possibility of replacing the base cup easily, it is possible to convert easily a filter holder with double spout into one with a single spout.

As shown in FIG. 9, the body 22 of the filter holder 20 is shaped so as to have a first front flange 27 and a second rear flange 28. Two open recesses, opposite to each other, are thus formed between the two flanges 27 and 28. The first front flange 27 is preferably diametrically opposite to the handle 21. The second rear flange is preferably substantially connected to a protruding part 211 of the handle 21. According to embodiments, the two flanges 27, 28 follow the substantially cylindrical profile of the body 22 of the filter holder 20.

According to embodiments, the first front flange 27 extends downwards by an amount greater than the second rear flange 28. The reason for this difference will be explained below. The free edge of the second rear flange 28 is preferably rounded.

The first front flange 27 comprises a first internal groove 271. The first internal groove 271 extends over the entire width of the first front flange 27 and opens out into the open recesses.

The second rear flange 28 comprises a second internal groove 281. The second internal groove 281 extends over the entire width of the second flange 28 and opens out into the open recesses.

Preferably, the first internal groove 271 and the second internal groove 281 are situated in a horizontal plane parallel to the plane of the top edge of the body 22.

According to one embodiment, at least one of the grooves comprises a retaining member 282 for keeping the base cup 30 in position when it is coupled to the body 22.

For example, the retaining member 282 may be a ball presser which is elastically prestressed (for example by means of a spring). The ball presser 282 may be situated inside the second groove 28, for example in the center thereof. The prestressing mechanism, which typically comprises a spring, may be housed in a protruding part 211 of the handle 21.

The filter holder body also comprises fins 25 configured to engage the filter holder 20 together with the dispensing unit of the espresso coffee machine.

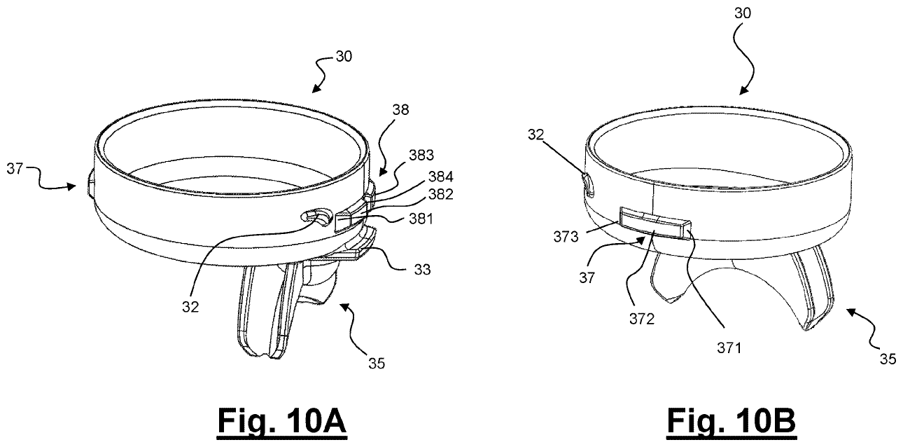

The base cup 30, which is configured to engage with the body 22 of the filter holder 20, is shown in FIGS. 10A and 10B. The base cup 30 has a cup-shaped form which is open at the top and substantially closed at the bottom. A spout 35-which may be single or double as shown in FIG. 10 and the following figures-projects from the bottom.

The base cup 30 comprises a side surface with two projecting teeth. a first front tooth 37 and a second rear tooth 38. The two teeth 37, 38 are substantially diametrically opposite to each other. The first front tooth 37 is configured to engage the first front groove 271. The second rear tooth 38 is configured to engage the second rear groove 281.

The first front tooth 37 may comprise an entry ramp 371, a substantially flat section 372 and an exit ramp 373.

Similarly, the second rear tooth 38 may comprise an entry ramp 381, a substantially flat section 382 and an exit ramp 383. The substantially flat section 382 is interrupted by a cylindrical seat 384. The cylindrical seat 384 is configured to engage with the retaining member 382 (ball presser).

According to embodiments, the base cup 30 may also comprise a protruding lug 33 which projects radially towards the outside from the bottom of the base cup. The lug 33 is situated preferably substantially underneath the second rear tooth.

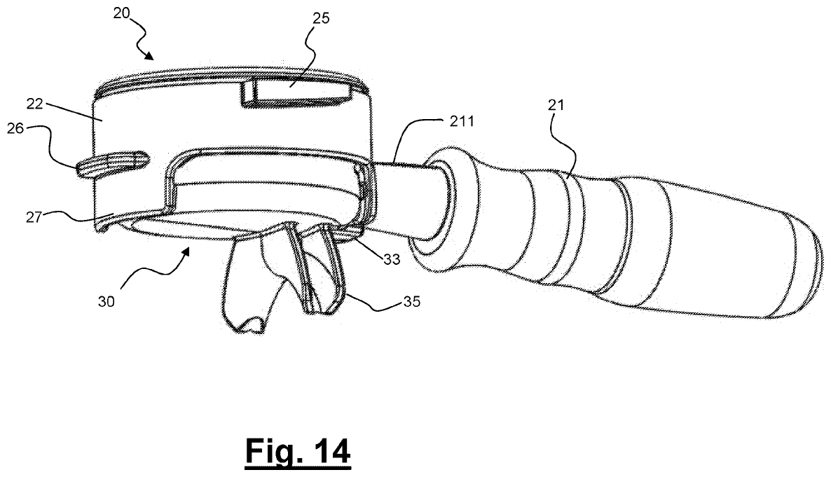

According to embodiments, the outer surface of the base cup 30 also comprises two oppositely arranged projecting whiskers 32. The two oppositely arranged whiskers 32 are configured, as shown in FIGS. 13 and 14, to determine the correct angular abutting position of the base cup 30 on the body 22 of the filter holder 20.

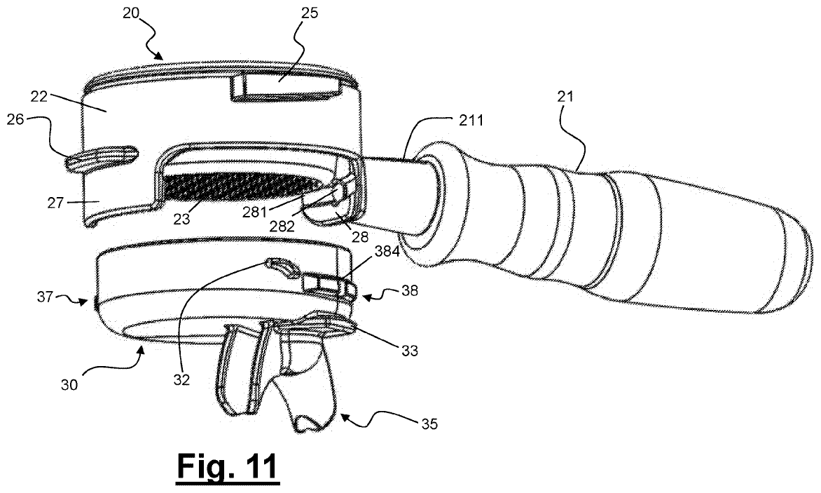

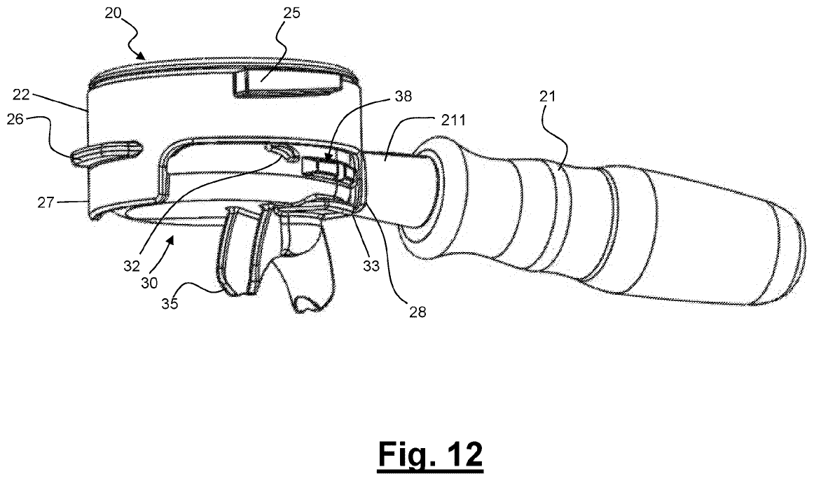

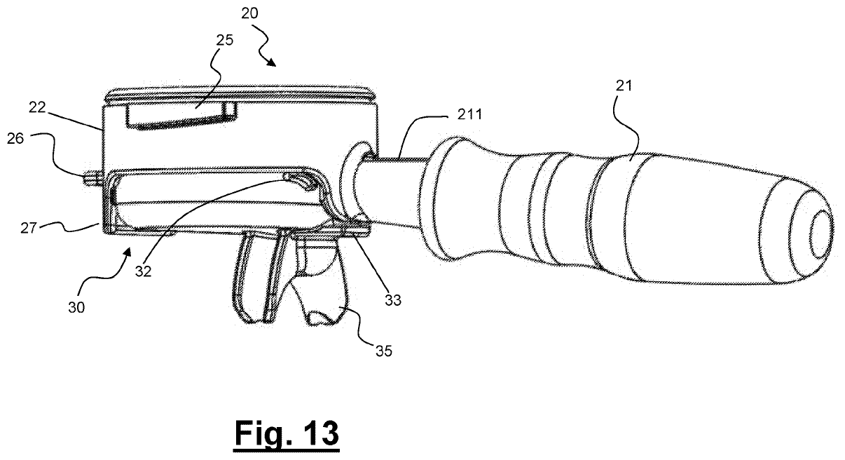

In order to couple the base cup 30 together with the filter holder body 22, the base cup 30 is inserted vertically (movement as shown in FIG. 11 and FIG. 12) into the seat of the filter holder and is then rotated so that the first front tooth 37 engages the first front groove 27 and the second rear tooth 38 engages the second rear groove 28. At the end of rotation the base cup is in the position shown in FIGS. 13 and 14. Advantageously, during the rotational movement, the ball of the ball presser 382 penetrates elastically inside the cylindrical seat 384 of the second tooth 38 and defines with precision the relative position of the base cup 30 and the body 22 of the filter holder. The entry and exit ramps facilitate the withdrawal of the ball of the ball presser inside its seat.

Furthermore, during the rotational movement, the lug 33 engages the bottom edge of the second rear flange 28. As mentioned above, the second flange 28 extends downwards less than the first flange 27. This in fact defines a unique relative position of the filter holder body and the base cup and prevents these parts from being mounted in a different position. In other words, should one try to rotate the base cup relative to the body in the opposite direction, this rotation would be prevented since the lug would collide against the front flange 27.

In order to remove the base cup 30, it is merely required to rotate the base cup relative to the body 22 of the filter holder, forcing the ball of the ball presser to come out of the cylindrical seat.

It is clear how the embodiment of FIGS. 9-14 is also particularly advantageous since the removal and reassembly operations do not result in any uncertainty in the positioning. The person mounting and removing the base cup is able to easily sense the correct mounting position.

Advantageously, the engaging/disengaging force required to mount/remove the base cup is extremely limited so as to allow essentially anyone to engage/disengage the base cup. This aspect is particularly advantageous when the espresso coffee machine is for domestic use.

Advantageously, according to the invention, the engaged base cup is rigidly retained by the filter holder and becomes essentially an integral part thereof. Accidental removal thereof is prevented even during the more forceful operations involving knocking the filter holder against the coffee grounds drawer in order to remove the used coffee puck.

Advantageously, owing to its low thermal conductivity, it is possible to remove or reassemble the base cup at any time, even in the case of high temperatures of the filter holder.

1. A filter holder for a machine for preparing and dispensing espresso coffee, comprising a handle, a body connected to the handle and configured to house a filter for ground coffee, and a base cup, wherein the base cup is substantially made of any material from among polysulfides, polyethers, polyaryletherketones, polyphenylsulfones and polysulfones, or the base cup is made of glass, or ceramic, or porcelain, or a combination thereof.

2. The filter holder of claim 1, where the base cup is substantially made of polyphenylene sulfide.

3. The filter holder of claim 1, wherein the base cup is substantially made of polyether ether ketone.

4. The filter holder of claim 1, wherein the base cup is substantially made of polyphenylsulfone.

5. The filter holder of claim 1, wherein the base cup is a component separate and/or separable from the body and wherein the body of the filter holder is substantially made of a metallic material having a thermal conductivity less than 150 W·m⁻¹·K⁻¹.

6. The filter holder of claim 5, wherein said metallic material is steel, preferably chrome-plated steel, or brass, preferably chrome-plated brass.

7. The filter holder of claim 1, wherein the body comprises a flat support member for supporting the filter holder to facilitate pressing of the ground coffee inside the filter.

8. The filter holder of claim 7, wherein the support member comprises a tooth protruding radially towards the outside of the body, preferably in a direction substantially opposite to the handle, and formed as one piece with the body.

9. The filter holder of claim 1, wherein the body comprises a first front flange with a first internal groove, a second rear flange with a second internal groove, and two opposite open recesses between the first flange and the second flange.

10. The filter holder of claim 9, wherein the first internal groove and the second internal groove open out into the open recesses, wherein the base cup comprises a first front tooth configured to engage the first internal groove and a second rear tooth configured to engage the second internal groove for coupling the base cup to the body.

11. The filter holder of claim 1, further comprising a retaining member, preferably a ball presser, for providing a further retaining action between the base cup and the body.

12. The filter holder of claim 9, further comprising a protruding lug configured to engage the free edge of the second rear flange.

13. The filter holder of claim 9, further comprising oppositely arranged whiskers configured to determine the correct angular abutting position of the base cup on the body of the filter holder.

14. The filter holder of claim 1, wherein the material of the base cup is a material resistant to contact with a liquid substance having a temperature of at least 100° C.
